(19) United States
(12) Patent Application Publication
(10) Pub. No.: US 2010/0227022 A1
(43) Pub. Date: Sep. 9, 2010

(54) Perceptive Liquid Beverage

(76) Inventor: Eric Korevaar, La Jolla, CA (US)

Correspondence Address: NYDEGGER & ASSOCIATES, 348 OLIVE STREET, SAN DIEGO, CA, 92103, US

(21) Appl. No.: 12/398,395

(22) Filed: Mar. 5, 2009

(51) Int. Cl. A23L 2/385; A23L 2/00

(52) U.S. Cl. 426/66

(57) ABSTRACT

A longevity drink and method for providing same requires the collection of waters from various global regions. Specifically, water portions without additives are collected from separate and distinct global regions, with the different regions being located more than one thousand nautical miles distant from each other. The various portions are then transported to a processing point where they are combined. In combination, each portion has a substantially same liquid volume. The combination of waters (elixir) is then packaged and distribution to consumers for consumption as a longevity drink.

### FIELD OF THE INVENTION

The present invention pertains generally to elixirs and longevity drinks. More specifically, the present invention pertains to a combination of diverse liquid waters that, when consumed together, may augment other health preserving activities for improving the longevity of the consumer. The present invention is particularly, but not exclusively, useful as a longevity drink that includes liquid waters from various global regions where the human population has extraordinary longevity.

### BACKGROUND OF THE INVENTION

Water is a colorless, transparent, odorless, tasteless liquid. It is, however, also the basis of fluids that are necessary for all living organisms. Insofar as human beings are specifically concerned, drinking water has many beneficial attributes. In particular, drinking water provides an excellent source for many of the minerals that are required for a healthy body. Further, humans commonly attribute specific health benefits to natural water that comes from particular sources.

An issue of interest to all mortals is their own longevity. While no single circumstance, activity, or nutrient can be realistically claimed to be solely responsible for increased longevity, a combination of these may be. On this point, it is well established that the combination of a proper diet, routine exercise, meaningful personal relationships, and a healthy lifestyle are significant contributors to increased longevity. For example, in an article entitled “The Secrets of Long Life” by Dan Buettner, with photographs by David McLain, which was printed in the National Geographic Magazine, November 2005, several global regions (i.e. “hot spots”) for extraordinary human longevity were identified.

Within the context identified in the National Geographic article, and for the purposes expressed herein, a global region is defined as an area of the world where there is evidence of extraordinary longevity (i.e. life expectancy for males and females is greater than 75 years). Typically, these global regions can also be characterized by an increased percentage of persons over the age of 100 years. Although such an area (i.e. global region) may have no fixed boundaries, it will nevertheless be generally circumscribed by the defining characteristic of extraordinary longevity. Within this definition, the above-noted National Geographic article specifically identifies three different global regions. They are: Sardinia, Italy; Okinawa, Japan; and Loma Linda, Calif.

To return to the water, it can be safely said that people within a global region will, for the most part, drink the same water.

With the above in mind, it is an object of the present invention to provide a water drink having a documented perception of extraordinary longevity. Another object of the present invention is to provide a drinking water having global diversity, but a common association with increased longevity. Still another object of the present invention is to provide a combination of waters (i.e. an elixir, a longevity drink) that is relatively easy to produce and is commercially cost effective.

### SUMMARY OF THE INVENTION

A combination of waters, and a method for providing this combination requires identifying global regions where extraordinary longevity has been identified. Water from each of these global regions is then collected and transported, in bulk, to a central processing point. Portions of water from each of the regions are then combined at the processing point and are packaged for distribution to consumers.

Important aspects of the water that is collected from the various global regions include: identified human longevity; unadulterated purity; and diversity. In order; it is first necessary to identify global regions where extraordinary human longevity is not uncommon. Fortunately, it happens there are several such regions in the world. More specifically, in this selection, it is preferable (i.e. essential) to identify regions where both males and females have an average life expectancy greater than about seventy-five years, and an increased percentage of persons live more than 100 years. Further, it is also necessary that the collected water portions remain pure (i.e. unadulterated and untreated) between the time they are collected in the global region, and the time they are subsequently commercialized in combination with water portions from other global regions. Stated differently, it is preferable that no chemical, physical or biological agents detrimental to longevity be added to the water portions either before or after they are collected.

Although it is noted above that additives which are detrimental to longevity should not be included in the collection of waters, the present invention recognizes that some additives may not have any detrimental effect. For example, selected teas or flavorings may be added without compromising the present invention. Also, routine maintenance of water supplies may not compromise the invention. Finally, in order to benefit from the world's plethora of health provisions, it is necessary that diverse water portions be collected from different global regions. On this point, previously identified global regions having the requisite diversity are: Sardinia, Italy; Okinawa, Japan; and Loma Linda in Southern California.

In providing the collection of waters (i.e. elixir; longevity drink) various portions of waters from different global regions are combined. Preferably, equal liquid volumes of respective water portions are used. It is, however, also envisioned that unequal portions may be combined, as desired. In any event, it is necessary to have a plurality of different water portions.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic drawing of a processor for use in combining water portions in accordance with the present invention; and

FIG. 2 is a pictorial depiction of a water source as envisioned for the present invention.

### DESCRIPTION OF THE PREFERRED EMBODIMENTS

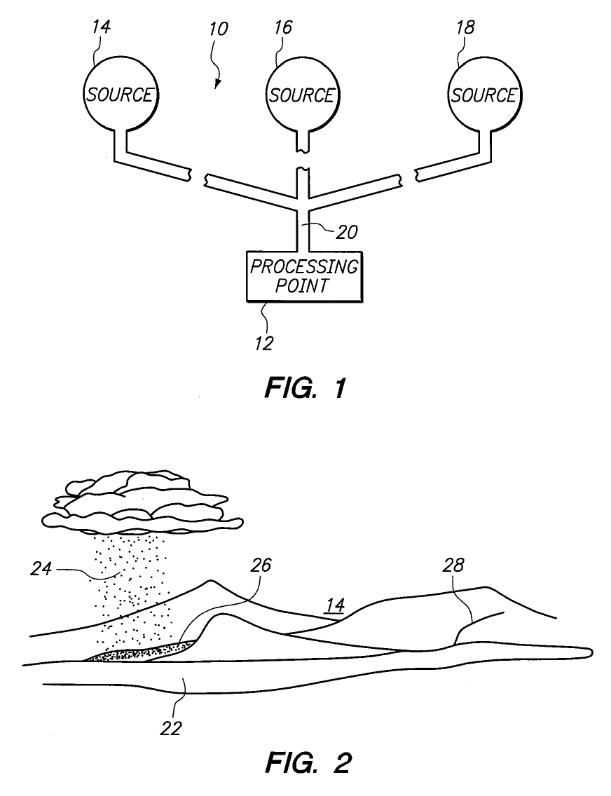

Referring initially to FIG. 1 a processing system in accordance with the present invention is shown and is generally designated 10. As shown, the system 10 includes a processing point 12 that is indirectly associated with a plurality of different water sources. The sources 14, 16 and 18 shown in FIG. 1 are only exemplary. As envisioned for the present invention, each of these sources 14, 16 and 18 is located in a different global region. Thus, as additional regions are identified, additional sources may also be used. Specifically, each global region is selected for having certain identifiable characteristics. Most importantly, each global region must have a demonstrated human longevity for both males and females. Preferably the average human longevity for a selected global region is equal to, or greater than, about seventy-five years. Further, and also important, each global region, and thus each respective source (e.g. sources 14, 16 and 18) needs to be more than one thousand nautical miles from any other source (i.e. global region).

As shown in FIG. 1, it is the purpose of the present invention to combine water portions from each of various global regions (e.g. sources 14, 16 and 18). To do this, water portions from the respective sources 14, 16 and 18 are brought into fluid communication with the processing point 12 through a common conduit 20. The combination of waters can then be further processed, packaged appropriately, and distributed to consumers (not shown). Importantly, as indicated above, the sources 14, 16 and 18, as well as other possible sources (not identified) are each collected from a respective global region. For instance, identified global regions having the criteria required for water portions that can be used for the present invention include: Sardinia, Italy; Okinawa, Japan; and Loma Linda, Calif. (Southern California).

FIG. 2 is a pictorial depiction of a typical water source in a global region (e.g. the source 14). As shown, the source 14 includes various examples of natural water supplies. These include a lake (or reservoir) 22 for receiving rainwater 24 that is fed from headwaters such as the river 26 and the stream 28. Underground waters (not shown) can also be part of the source 14. In any event, it is an important aspect of the present invention that water collected from the source 14, as well as the other sources 16 and 18, be pure. Specifically, additives (such as chemical, physical or biological agents) should not be added to the water at any time after it has been collected. This prevention needs to be continued as the water is transported and conveyed to the processing point 12 for subsequent commercialization.

While the particular Perceptive Liquid Beverage as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for providing water as a longevity drink, the method comprising the steps of:
collecting portions of liquid water from a plurality of selected sources, wherein each source is located in a global region separate and distinct from the global region of other sources;
transporting the collected portions of liquid water to a processing point;
combining the portions of liquid water at the processing point; and
packaging the combined portions for distribution to consumers for consumption as a longevity drink.

2. A method as recited in claim 1 further comprising the step of preventing additives being included in the longevity drink wherein the additives are detrimental to longevity.

3. A method as recited in claim 2 wherein the preventing step includes the step of ensuring the longevity drink remains unaltered after collection from its respective source by the addition of an agent selected from a group of agents consisting of chemical, physical and biological agents detrimental to longevity.

4. A method as recited in claim 1 wherein at least two portions of the longevity drink have a substantially same liquid volume.

5. A method as recited in claim 1 wherein each global region is more than one thousand nautical miles from every other global region.

6. A method as recited in claim 1 wherein global regions are selected from a group consisting of Sardinia, Okinawa and Southern California.

7. An elixir which comprises a plurality of individual portions, wherein each portion of the elixir is liquid water collected from a selected source in a respective global region.

8. An elixir as recited in claim 7 wherein at least two portions of the elixir have a substantially same liquid volume.

9. An elixir as recited in claim 8 further comprising an additional portion of liquid water, and wherein the additional portion of the elixir has a substantially same liquid volume as the other portions.

10. An elixir as recited in claim 7 wherein each global region is more than one thousand nautical miles from every other global region.

11. An elixir as recited in claim 7 wherein global regions are selected from a group consisting of Sardinia, Okinawa and Southern California.

12. An elixir as recited in claim 7 wherein each portion of the elixir remains unaltered by inclusion of an agent detrimental to longevity after collection from its respective source.

13. An elixir as recited in claim 7 wherein each global region is characterized by an extraordinary human longevity, wherein the average longevity for a male and for a female is each greater than seventy five years.

14. A combination of drinking waters which comprises:
a first portion of liquid water, wherein the first portion of water is collected from a selected source in a first global region; and
a second portion of liquid water, wherein the second portion of water is collected from a selected source in a second global region, and wherein the second global region is more than one thousand nautical miles from the first global region.

15. A combination of drinking waters as recited in claim 14 wherein at least one additional portion of liquid water is combined with the first and second portions.

16. A combination of drinking waters as recited in claim 14 wherein the combination is prevented from including additives.

17. A combination of drinking waters as recited in claim 16 wherein the combination remains unaltered after collection from its respective source by preventing the addition of an agent detrimental to longevity, wherein the agent is selected from a group of agents consisting of chemical, physical and biological agents.

18. A combination of drinking waters as recited in claim 16 wherein at least two portions of the combination have a substantially same liquid volume.

19. A combination of drinking waters as recited in claim 14 wherein each global region is noted for longevity.

20. A combination of drinking waters as recited in claim 14 wherein global regions are selected from a group consisting of Sardinia, Okinawa and Southern California.
